(19) United States
(12) Patent Application Publication
(10) Pub. No.: US 2009/0100564 A1
(43) Pub. Date: Apr. 23, 2009

(54) SCRATCHABLE PRINTED TEXTILE SUPPORT AND DRESS ITEM CONSISTING OF SAID SUPPORT

(76) Inventors: Pierre-Jean Reydellet, Lent (FR); Guillaume Abou, Lyon (FR); Philippe Alzina, Carcasonne (FR)

Correspondence Address: CANTOR COLBURN, LLP, 20 Church Street, 22nd Floor, Hartford, CT, 06103, US

(21) Appl. No.: 11/915,527

(22) PCT Filed: May 26, 2006
(86) PCT No.: PCT/FR2006/050483

§ 371 Date: Jul. 21, 2008

(30) Foreign Application Priority Data
May 26, 2005 (FR) 0551381

(51) Int. Cl. A41D 1/00; B32B 3/10; B05D 5/00; C09D 11/00

(52) U.S. Cl. 2/69; 428/196; 427/288; 106/31.6

(57) ABSTRACT

Woven or knitted textile printed support covered over all or part of the printed surface with a scratchable ink, characterized in that the scratchable ink is applied directly on all or part of the printed surface.

### FIELD OF THE INVENTION

The disclosure relates to a printed textile support, useable in particular in the fields of communication, promotion on the one hand, fashion and sportswear on the other. More precisely, it relates to a printed textile support, on which an ink is applied which, after scratching, allows the original print to appear. It also relates to a scratchable ink for application to a printed textile support.

### BACKGROUND

Printed textiles, and in particular tee-shirts, represent a very large market for the field of communication, promotion on the one hand, and fashion and sportswear on the other. This common consumer good is in fact an inexpensive media support, easy to produce for occasional events of the type such as shows, festivals, advertising campaigns and other. In an exemplary embodiment, the Applicant has formed the idea of making these printed textile supports scratchable, to make them into completely novel products for an evolving market.

In one exemplary embodiment, the printed textile support is a tee-shirt, a sweatshirt, a polo-necked sweater, a shirt, a pullover, an undergarment, and more broadly, any dress textile support suitable for printing.

The principle of scratchable ink is known on paper supports. Printed paper supports are known in the field of games in particular, in which part of them is covered with an ink intended for scratching by the user to allow the hidden inscription to appear. Several methods and inks have been proposed for this purpose. Document FR-A-2 595 987, for example, describes a method by photogravure consisting in applying a protective varnish to the inscription to be hidden on the paper support, and then only applying to the varnish, a first coat of a brittle and opaque ink, followed by a second coat of an ordinary coloured ink. The intermediate varnish layer has the function of sealing the paper and facilitating the scratching. Document US 2002/0028321 describes an offset method in which the printed paper is previously sealed using an aqueous UV primer. This primer is then covered with a UV coating, on which the layer of scratchable ink is applied by offset. Document U.S. Pat. No. 6,497,759 B1 describes a scratchable ink for direct application to the print of a paper support, without an intermediate layer.

Document US2002/0029713 describes a method for printing calling cards, in particular, and more generally paper, with a scratchable ink by transfer. It refers incidentally to the possibility of using a woven or non-woven material as a support. No exemplary application is provided. In practice, transfer is a technique whereby a layer of ink followed by a layer of adhesive is printed on a film. The film is then turned over and applied to the support to be printed. On the assumption that the support is a textile support and that the ink is a scratchable ink, the end product can be expected to be unsatisfactory in two essential aspects. The first is that the scratching is not optimal because part of the ink is liable to remain trapped by the adhesive. Moreover, a certain proportion of adhesive should subsist on the textile surface, even after washing. In other words, the textile supports thus obtained cannot be applied to dress items.

In other words, the problem that the invention proposes to solve is to provide a woven or knitted textile which does not have the abovementioned drawbacks and which, in consequence, can be applied to dress items.

### SUMMARY OF THE INVENTION

Thus, an exemplary embodiment of the disclosure relates to a woven or knitted textile printed support covered over all or part of the printed surface with a scratchable ink, the said support being characterized in that the scratchable ink is applied directly on all or part of the printed surface, advantageously on the entire printed surface.

Due to the direct printing, only the ink is scratched at the time of scratching, so that it leaves no trace after washing.

The textile printing and paper printing can be carried out by similar techniques, but with radically different inks, due to the nature of the support.

In a first exemplary embodiment, the support of the invention is printed by a water-soluble or solvent-based ink.

In a second exemplary embodiment, the support of the invention is printed by a plastisol ink. In practice, this plastisol ink is applied by screen printing.

Most of the inks applied to textiles, in particular for the tee-shirt market, are in fact plastisol inks, that is, inks containing PVC dispersed in one or more plasticizers to which pigments are added. The presence of the PVC and plasticizers serves to fix the ink on the textile material. Furthermore, these inks have the advantage of being fast over time, both in terms of colour and appearance. In particular, the plastisol ink printed on a textile is not damaged by the passage in a washing machine. Moreover, the opacity of this ink serves to print it on dark supports. Finally, plastisols are inks that are easy to apply by screen printing. This is why nearly 80% of the regular consumer textile market, particularly tee-shirts, makes use of plastisol inks.

Contrary to printed paper supports used in particular in the field of games in which the rendering of the print after scratching is not an essential criterion, plastisols printed on tee-shirts must remain intact for obvious reasons of appearance, that is, without damage after scratching of the scratchable ink by the nail. In fact, plastisol inks are brittle and rough.

To keep the plastisol ink intact after scratching, the scratchable ink is applied directly over all or part of the printed surface and advantageously contains one or more water-soluble binders, pigments and mineral fillers.

This type of formulation serves to have an ink that is sufficiently soft (presence of water-soluble binder) and sufficiently friable (presence of filler) to guarantee effective scratching and to obtain a perfectly clean textile after washing.

Preferably, the scratchable ink contains:
between 40 and 70% by weight of a water-soluble binder,
between 5 and 10% by weight of pigments,
between 20 and 30% by weight of mineral filler.

In an exemplary embodiment, the water-soluble binder is selected from the group comprising polyvinyl alcohol and polyquarternium. Similarly, the mineral filler is preferably calcium carbonate.

To improve its strength, the ink further contains between 5 and 25% by weight of an aqueous acrylic-polyurethane dispersion.

The disclosure also relates to a dress item such as, for example tee-shirt, sweatshirt, polo-necked jersey, shirt, pullover, undergarment consisting of a woven or knitted textile printed support covered over all or part of the printed surface with a scratchable ink. In an exemplary embodiment, the scratchable ink is applied directly, preferably by screen printing.

The disclosure also relates to the scratchable ink previously described intended for application to a woven or knitted textile.

It also relates to a method for producing a scratchable printed textile whereby:
all or part of a textile is printed using a water-soluble or solvent-based ink, or advantageously a plastisol ink,
a scratchable ink is applied directly on all or part of the said ink.

In practice, the two printings are carried out by screen printing.

### BRIEF DESCRIPTION OF THE FIGURES

The invention and its advantages will appear more clearly from the following exemplary embodiments.

FIG. 1 is a photograph of a support printed with a plastisol ink and covered with a scratchable ink for paper.

FIG. 2 is a photograph of the support in FIG. 1 covered with a scratchable ink of the invention.

### DETAILED DESCRIPTION

### Example 1

An ink is prepared having the following composition (by weight):

| | |
|---|---|
| aqueous dispersion of polyvinyl alcohol: | 50% |
| aqueous acrylic-polyurethane dispersion: | 10% |
| aqueous dispersion of pigments: | 8% |
| surfactant: | 3% |
| calcium carbonate: | 29% |

This ink is applied to a tee-shirt previously printed by a plastisol ink. The application of the scratchable ink is carried out by screen printing. After scratching, the plastisol ink remains intact.

### Example 2

In this example, the performance of the scratchable ink of the invention is compared with that of a scratchable ink used in the field of paper.
scratchable ink of the invention: ditto example 1
scratchable ink for paper: VFP, ref UN1210—GRAD ARGENT DIRECT, serial No./batch: 502093

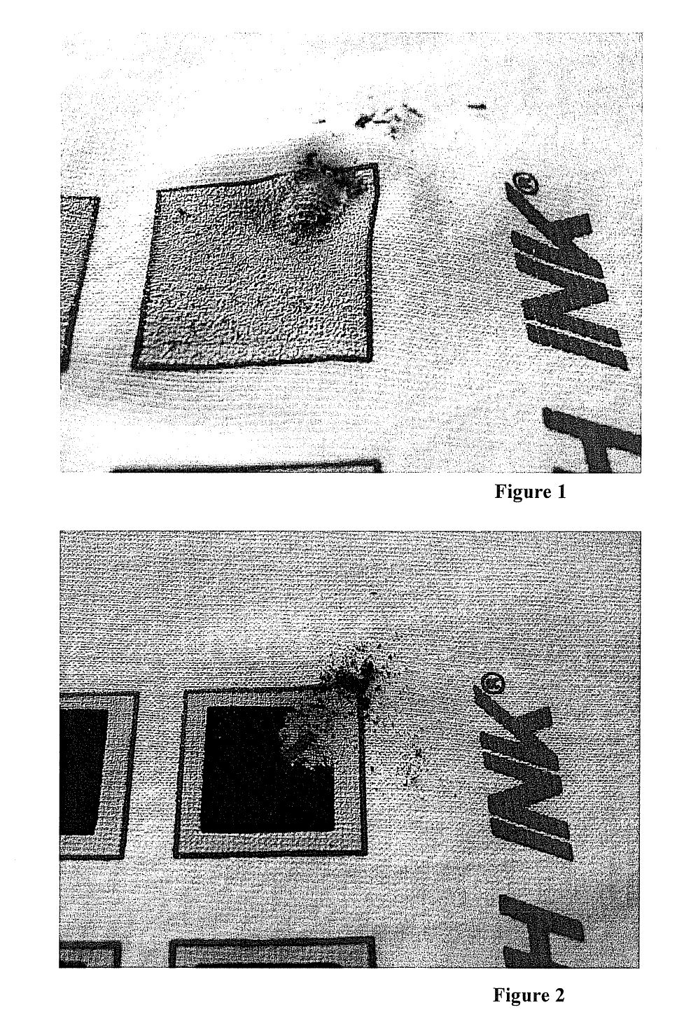

FIGS. 1 and 2 are photographs of tee-shirts printed using a plastisol ink.

The plastisol in FIG. 1 is itself covered with a paper scratchable ink. As shown in FIG. 1, the ink adheres to the printed support and is not detached, even with vigorous scratching. On the other hand, the ink of the invention (FIG. 2) is detached by scratching, without damaging the printed support below.

1. Woven or knitted textile printed support covered over all or part of the printed surface with a scratchable ink, characterized in that the scratchable ink is applied directly on all or part of the printed surface.

2. The support according to claim 1, wherein the support is printed by a plastisol ink.

3. The support according to claim 2, wherein the support is printed by screen printing.

4. The support according to claim 1, wherein the scratchable ink contains:
between 40 and 70% by weight of a water-soluble binder,
between 5 and 10% by weight of pigments,
between 20 and 30% by weight of mineral filler.

5. The support according to claim 4, wherein the mineral filler is calcium carbonate.

6. The support according to claim 4, wherein the ink further contains between 5 and 25% by weight of an aqueous acrylic-polyurethane dispersion.

7. Dress item such as at least one of a tee-shirt, sweat-shirt, polo-necked jersey, shirt, pullover, undergarment consisting of a woven or knitted textile printed support covered over all or part of the printed surface with a scratchable ink.

8. Scratchable ink for application to a woven or knitted textile and comprising:
between 40 and 70% by weight of a water-soluble binder,
between 5 and 10% by weight of pigments,
between 20 and 30% by weight of mineral filler.

9. Method for producing the support according to one claim 1, characterized in that:
all or part of a textile is printed using a water-soluble or solvent-based ink,
a scratchable ink is applied directly on all or part of the said ink.

10. The method according to claim 9, wherein the two printings are carried out by screen printing.
